(19) United States
(12) Patent Application Publication
(10) Pub. No.: US 2025/0253472 A1
(43) Pub. Date: Aug. 7, 2025

(54) BATTERY HOLDER

(71) Applicant: JackRabbit Mobility Inc., La Jolla, CA (US)

(72) Inventors: Jason B. Kenagy, La Jolla, CA (US); D’Arcy O’Connor, Victoria (CA); Jan K. Lezny, La Jolla, CA (US); Thomas M. Piszkin, Santee, CA (US)

(73) Assignee: JackRabbit Mobility Inc., La Jolla, CA (US)

(21) Appl. No.: 19/044,078

(22) Filed: Feb. 3, 2025

Related U.S. Application Data
(60) Provisional application No. 63/549,858, filed on Feb. 5, 2024.

(51) Int. Cl. H01M 50/249; B60L 58/16; B62J 43/10; H01M 10/42; H01M 10/48; H01M 50/271

(52) U.S. Cl. CPC H01M 50/249; B60L 58/16; B62J 43/10; H01M 10/425; H01M 10/482; H01M 10/486; H01M 50/271; B60L 2200/12; B60L 2240/545; B60L 2240/547; H01M 2010/4271; H01M 2220/20

(57) ABSTRACT

A battery holder for an electric personal transport vehicle includes a first receptacle and a second receptable. Each receptacle is configured to accommodate an outer battery pack. A cavity is between the first receptacle and the second receptacle. The cavity is configured to accommodate a central battery pack. An upper cap is coupled to a top surface of the first receptacle and the second receptable, and covers the cavity. A lower cap includes a first retaining portion coupled to the first receptacle, a second retaining portion coupled to the second receptacle, and a base. The base is between and coupled to each of the first retaining portion and the second retaining portion, and covers the cavity. The base has an inner surface configured to abut to an external structure when securing the battery holder. The external structure is a component of the electric personal transport vehicle.

### RELATED APPLICATIONS

This application claims priority to U.S. Provisional Patent Application No. 63/549,858 filed on Feb. 5, 2024, which is hereby incorporated by reference in full.

### BACKGROUND

Electric Personal Transport Vehicles (EPTV) is a classification that includes eBikes, eBicycles, eScooters, eTrikes, eMopeds, eMotorcycles, and other small electric personal transport vehicles, that have gained widespread popularity as a preferred mode of transportation. These EPTVs operate using an electric motor, either exclusively or in conjunction with human pedaling. Generally, the motor is powered by a battery pack that supplies the necessary electrical energy to propel and move the EPTV. A battery pack comes in various form factors with designs tailored to balance factors such as capacity, range, size, weight and integration. Most EPTVs have a primary battery pack, and some models may incorporate a secondary battery pack and/or an auxiliary battery pack. The battery packs, including the primary, secondary and auxiliary units can be mounted externally to the frame assembly or other component of the EPTV, and/or integrated into the frame assembly. Battery packs can enhance performance by extending range and can be designed for aesthetic appeal.

### SUMMARY

A battery holder for an electric personal transport vehicle includes a first receptacle and a second receptable. Each receptacle is configured to accommodate an outer battery pack. A cavity is between the first receptacle and the second receptacle. The cavity is configured to accommodate a central battery pack. An upper cap is coupled to a top surface of the first receptacle and the second receptable, and covers the cavity. A lower cap includes a first retaining portion coupled to the first receptacle, a second retaining portion coupled to the second receptacle, and a base. The base is between and coupled to each of the first retaining portion and the second retaining portion, and covers the cavity. The base has an inner surface configured to abut to an external structure when securing the battery holder. The external structure is a component of the electric personal transport vehicle.

### BRIEF DESCRIPTION OF THE DRAWINGS

FIGS. 1A-1D are side views of electric bicycles, as known in the art.

FIGS. 1E-1K illustrate various examples of electric personal transport vehicles (EPTVs) equipped with a battery holder, in accordance with some embodiments.

FIGS. 2A-2E are various views of a battery holder with or without a central battery pack, all in accordance with some embodiments.

FIG. 2F is a section view A-A of FIG. 2E, in accordance with some embodiments.

FIG. 3A is a side view of an EPTV with a battery holder, in accordance with some embodiments.

FIG. 3B is a perspective view of an EPTV with a battery holder, in accordance with some embodiments.

FIGS. 4A and 4B show perspective views of a battery holder with a central battery and with the lower cap removed, both in accordance with some embodiments.

FIG. 5A is a side view of a portion of an EPTV with the battery holder removed, in accordance with some embodiments.

FIG. 5B is a top view of a portion of the frame of an EPTV with the battery holder removed, in accordance with some embodiments.

FIG. 6A shows a section view B-B of FIG. 2D excluding a battery management system (BMS), in accordance with some embodiments.

FIG. 6B shows a section view B-B of FIG. 2D with a BMS, in accordance with some embodiments.

FIG. 7 is an electrical schematic of the EPTV, in accordance with some embodiments.

FIG. 8 is an electrical schematic of the BMS and battery cells, in accordance with some embodiments.

FIGS. 9A and 9B show side views of an EPTV, both in accordance with some embodiments.

FIG. 10 is a schematic for a configuration for the battery holder for the EPTV, all in accordance with some embodiments.

### DETAILED DESCRIPTION

Electric Personal Transport Vehicles (EPTVs) provide efficient and sustainable alternatives to conventional transportation. EPTVs encompass a wide range of electrically powered or assisted personal mobility solutions, including pedal-assist and throttle-controlled vehicles. Some of these EPTVs may be known as Electric-Assisted Personal Vehicles (EAPVs), Electric Micromobility Vehicles (EMVs), Light Electric Vehicles (LEVs) or Personal Electric Vehicles (PEVs), and some examples include eBikes, eBicycles, eScooters, eTrikes, eMopeds, eMotorcycles, and other small electric personal transport vehicles. These vehicles play a crucial role in urban mobility, reducing congestion and emissions while offering enhanced convenience and accessibility. This disclosure pertains to systems and components that can be integrated into EPTVs ensuring compatibility across various configurations, including both pedal-assisted and fully electric models.

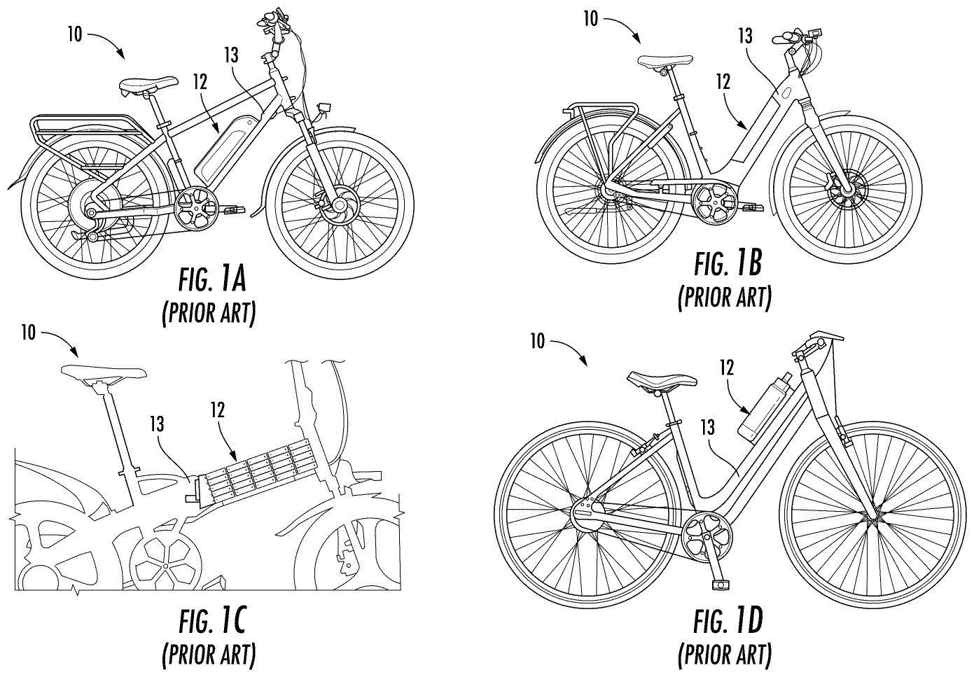

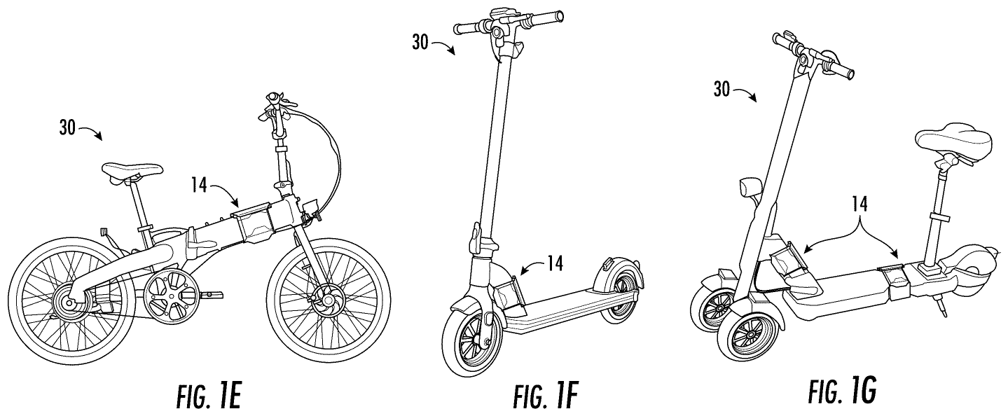

EPTVs may share common components with their traditional non-electric counterparts but are distinct in their inclusion of a battery pack electrically connected to a motor. The battery pack supplies electrical energy to the motor, and the motor, in turn, drives the rotation of the wheels, propelling the EPTV. In the art, battery packs may be mounted on the EPTV in various positions including externally mounted to a frame or to another component such as a rear rack or seat tube, and/or integrated into the frame. FIGS. 1A-1D are side views of electric bicycles, as known in the art. It will be appreciated that other EPTVs could be depicted such as eScooters, eTrikes, eMopeds, eMotorcycles, or other small electric personal transport vehicles. FIG. 1A depicts the eBike 10 with a battery pack 12 mounted externally to a frame 13 (or downtube), and FIG. 1B shows the battery pack 12 integrated into the frame 13 and form part of the structure of the frame 13 of the eBike 10. FIG. 1C shows the battery pack 12 of the eBike 10 completely within the frame 13 and hidden from view, and FIG. 1D shows the battery pack 12 disguised as a water bottle and externally mounted to the frame 13 of the eBike 10.

The present embodiments provide a battery holder to secure batteries for an EPTV, including one or more receptacles for battery packs mounted externally to a component of the EPTV. In some examples, this component may be a structural element such as a portion of the frame, downtube, rack, or panel. Throughout this disclosure, “frame” will be used as the representative component. A cavity is included to accommodate a central battery pack mounted internally to the frame of the EPTV. Due to the internal mounting of the central battery pack within the component, the central battery pack exerts no weight on the battery holder and the need for material and structural components to support the weight of the central battery pack are eliminated. In the present embodiments, the component (e.g., frame) serves the dual purpose of housing and safeguarding the central battery pack.

The battery holder positions distinct battery packs adjacent to one another aligning individual battery packs side-by-side. The battery holder utilizes a component of the EPTV to conceal a portion of the battery packs which optimizes space. An upper cap is coupled to a top surface of the one or more receptacles and covers the cavity, and a lower cap covers the bottom surface of the one or more receptacles and the cavity. When mounting the battery holder to the EPTV, the lower cap attaches the battery holder onto an external structure. The upper cap and lower cap establish a sealed system for the battery holder upon installation on the external structure. This closed system ensures a robust and durable structure, effectively safeguarding the battery packs.

In some embodiments, the upper cap envelops or covers the cavity defining a top of the cavity and the lower cap covers the cavity defining a bottom of the cavity. The upper cap, the lower cap, and one or more receptacles collectively shape or define the cavity. The upper cap and the lower cap also enclose the one or more receptacles. The upper cap and the lower cap not only encase the one or more receptacles but also interconnect them, securing the outer battery packs to the cavity which holds the central battery pack. This integration establishes a robust structural unit, significantly minimizing the likelihood of the one or more receptacles, the cavity, or battery packs experiencing bending, twisting, breakage, or damage.

This design of the upper cap and the lower cap connecting the one or more receptacles and the cavity, imparts strength and integrity to the battery holder as a unified entity, eliminating the need for additional components to reinforce the one or more receptacles. For instance, during transport when the battery holder, along with the battery packs, is separate from the EPTV, it forms a resilient and secure unit, shielding the battery packs from potential harm. When installed on the EPTV, the battery holder presents a sleek, slim profile to the frame, contributing structural strength and integrity. This reduces the risk of damage or detachment of the battery holder or the one or more receptacles during use, ensuring a durable and reliable assembly.

The battery packs are electrically connected to a battery management system (BMS) that is configured to actively monitor and control various parameters to optimize performance while preventing potential issues that could lead to damage or reduced battery life. The present embodiments enable easy access and convenience to the battery holder and/or battery packs. The battery holder, including the battery packs, can be easily and quickly removed when necessary, such as to prevent theft from an unattended EPTV or to transport the battery packs separately from the EPTV. For example, some batteries are not permitted in checked baggage during air travel.

FIGS. 1E-1K illustrate various examples of EPTVs equipped with one or more battery holders, in accordance with some embodiments. FIG. 1E shows a schematic of an example of an EPTV 30 that is an eBike or eBicycle with a battery holder 14. FIG. 1F shows a schematic of example of an EPTV 30 that is an eScooter with a battery holder 14. FIG. 1G shows a schematic of example of an EPTV 30 that is an eScooter with two battery holders 14. FIGS. 1H and 1I show schematics of examples of an EPTV 30 that is an eTrike with a battery holder 14. FIG. 1J shows a schematic of an example of an EPTV 30 that is an eMoped with two battery holders 14. FIG. 1K shows a schematic of an example of an EPTV 30 that is an eMotorcycle with a battery holder 14.

The depicted EPTVs 30, including one or more battery holders 14, may include both pedal-assisted and fully electric models. Examples shown include an eBike, eScooter, eTrike, eMoped, and eMotorcycle. In other embodiments, the EPTV may be a small electric personal transport vehicle. The battery holder 14 is depicted mounted in a specific location on the EPTV 30. It will be appreciated that the battery holder 14 may be positioned in other locations on the EPTV depending on design and functional requirements. In some embodiments, the EPTVs 30 may have one or more battery holders 14.

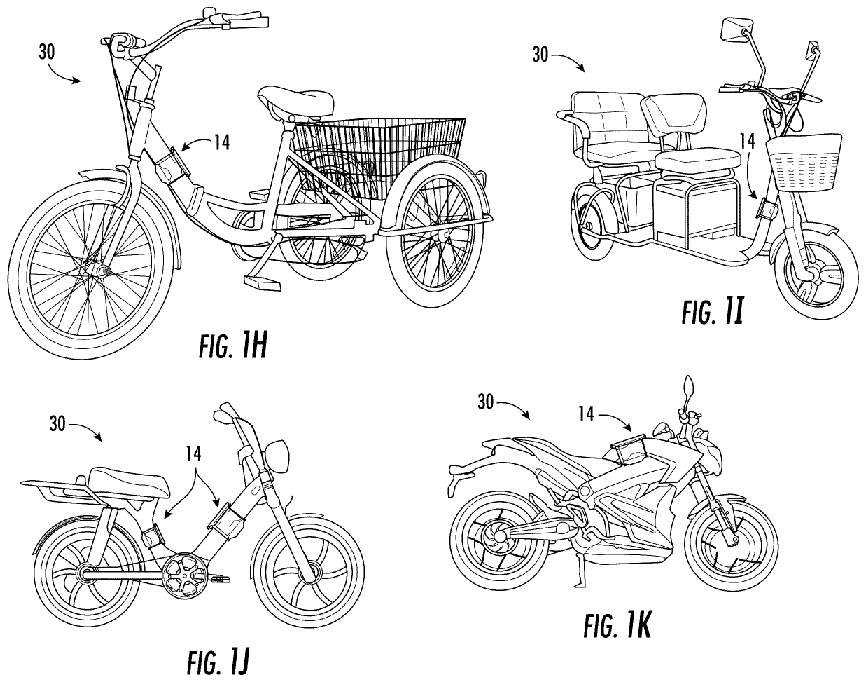

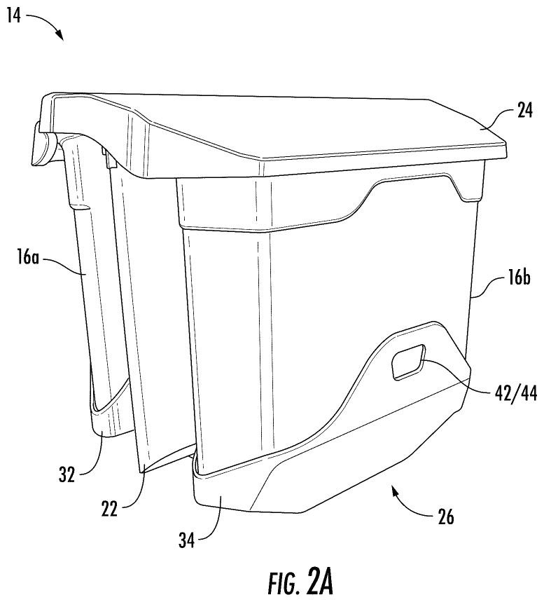

FIGS. 2A-2E are various views of a battery holder with or without central a battery pack for an EPTV, all in accordance with some embodiments. FIG. 2A is a perspective view of a battery holder and a central battery pack, FIG. 2B is a side view of a battery holder, FIG. 2C is a side view of a battery holder with and a central battery pack, FIG. 2D is a front view of a battery holder, and FIG. 2E is a top view of a battery holder. A battery holder 14 is a protective enclosure that securely houses and stabilizes battery packs for an EPTV. Further, the battery holder 14 prevents unwanted movement or shifting of the battery packs when installed in the battery holder 14 on the EPTV during travel or transport, ensuring a secure and stable placement. By effectively restraining the battery packs within its receptable or cavity, the battery holder 14 enhances the safety and reliability of the EPTV without the risk of unexpected shifts or disruptions during transit. The battery holder 14 includes one or more receptacles. Each receptacle 16a, 16b, 16c . . . 16n is configured to accommodate an outer battery pack. In some cases, lower cap 26 is configured to couple the battery holder 14 to a component of the EPTV (as described further in later sections).

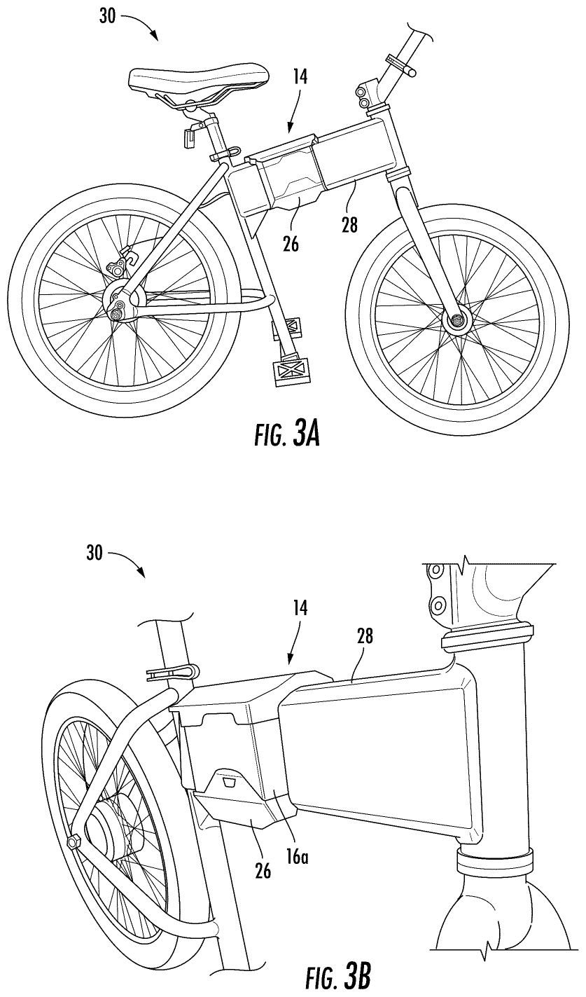

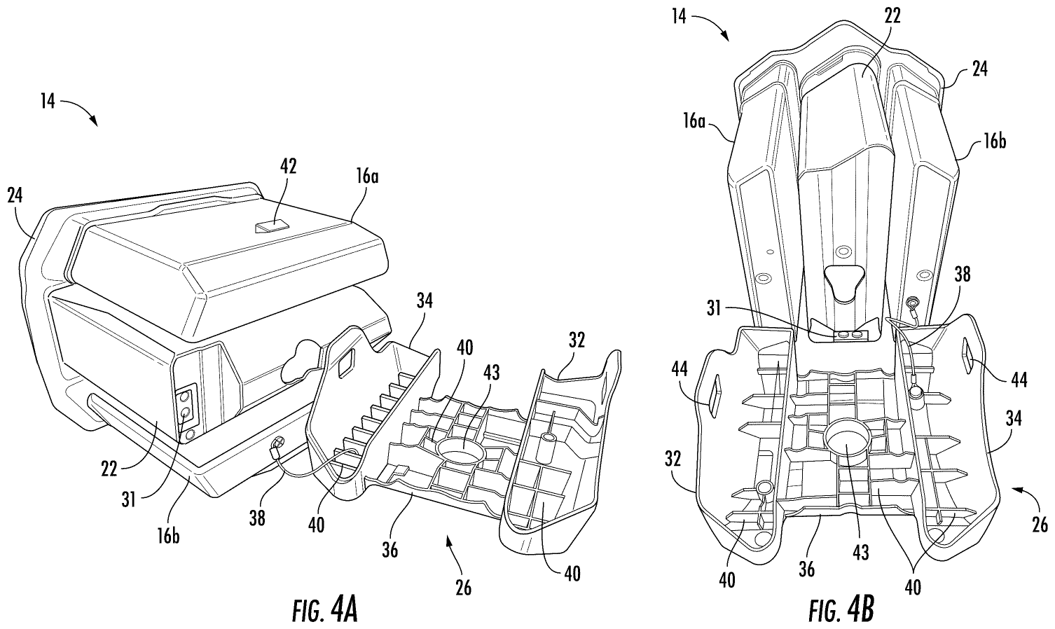

In some embodiments, a cavity 20, as shown in FIG. 2B, is positioned between a first receptacle 16a of the one or more receptacles and a second receptacle 16b of the one or more receptacles. The cavity 20 is essentially an open space between the first receptacle 16a and the second receptacle 16b and configured to accommodate a central battery pack 22. The width of the cavity labeled as X in FIGS. 2B and 5B is sized to accommodate the central battery pack 22 and the thickness of the component (e.g., frame 28) of the EPTV 30 including any lip or roll in the frame. The thickness of the frame (including some additional space for tolerance) is labeled as Y in FIGS. 2C and 5B. In some embodiments, the width of the cavity X is 30 mm to 35 mm and the thickness of the frame Y is 1.5 mm to 3 mm.

An upper cap 24 is coupled to a top surface of the one or more receptacles and covers the cavity 20. In some embodiments, there is a first receptacle 16a and second receptacle 16b. FIG. 2F is a section view A-A of FIG. 2E, in accordance with some embodiments. The upper cap 24 has an overlapping design to the first receptacle 16a, the second receptacle 16b and the central battery pack 22. The upper cap 24 provides a secure and protective barrier that extends beyond the edges of the underlying receptacles. This overlapping feature ensures comprehensive coverage and safeguarding preventing water or debris from entering the receptacles and battery packs 18 and 22. The overlapping upper cap 24 also contributes to the structural integrity, rigidity and robustness of the battery holder 14.

The upper cap 24 may be coupled to a top surface of the one or more receptacles by an adhesive or mechanical fastener. In some embodiments, the mechanical fastener are screws, bolts, nuts, rivets, hook and loop, or magnet. In some embodiments, the one or more receptacles (e.g., the first receptacle 16a and the second receptacle 16b) and the upper cap 24 are each made from a cast, molded or formed material. In some embodiments, the one or more receptacle and upper cap 24 are comprised of a rigid, polymer such as acrylonitrile butadiene styrene (ABS) and may be injection molded. In some embodiments, other rigid materials may be used such as a metal, composite material (e.g., a carbon fiber composite), or advanced ceramic. Further, other manufacture methods and processes may be used such as blow molding, machining or 3D printing.

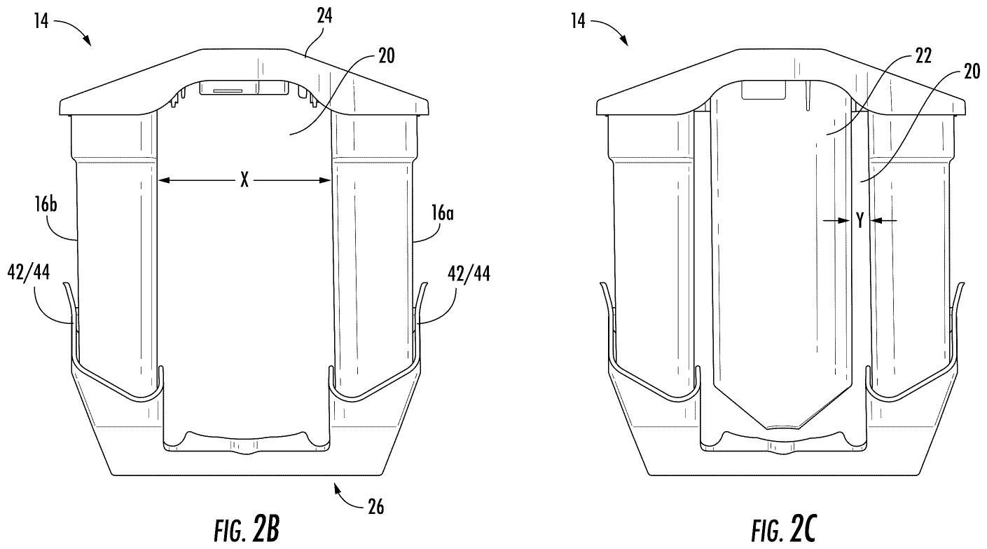

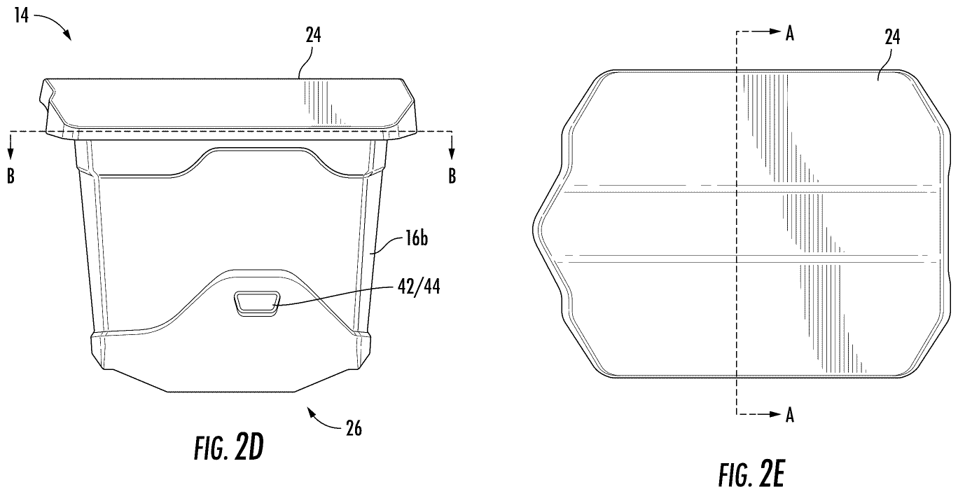

FIG. 3A is a side view of an EPTV with a battery holder, and FIG. 3B is a perspective view of an EPTV with a battery holder, both in accordance with some embodiments. In these particular figures, an eBike is depicted as the representative EPTV; however, any EPTV, including those illustrated in FIGS. 1E-1K, may be used interchangeably. In an aspect of the present embodiments, a lower cap 26 is configured to couple the battery holder 14 to a frame 28 of the EPTV 30.

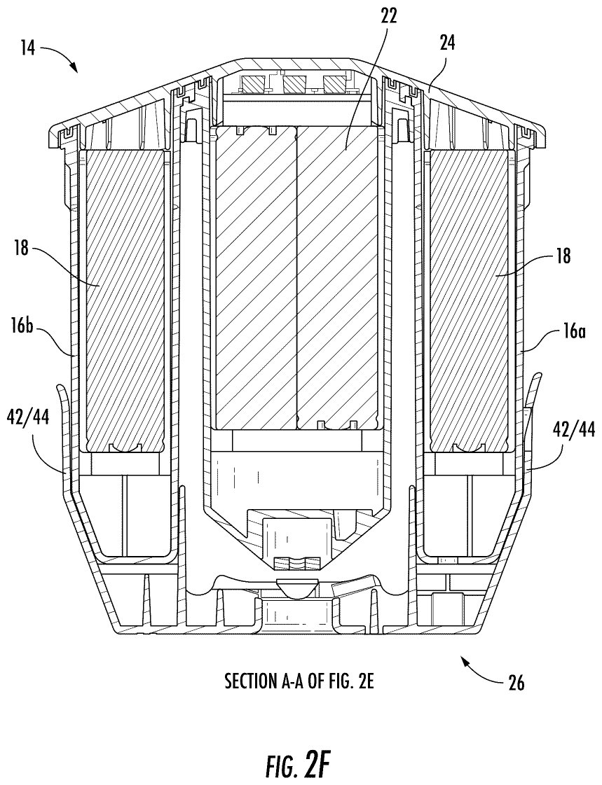

FIGS. 4A and 4B show perspective views of a battery holder with a central battery pack and with the lower cap removed, both in accordance with some embodiments. The central battery pack 22 is shown in the battery holder 14. The central battery pack 22 includes electrical contacts 31. The lower cap 26 comprises a first retaining portion 32, a second retaining portion 34 and a base 36. The base 36 is between and coupled to each of the first retaining portion and the second retaining portion. The first retaining portion 32 couples to the first receptacle 16a, and the second retaining portion 34 couples to the second receptacle 16b. The upper cap 24 defines a top of the cavity 20, the base 36 of the lower cap 26 defines a bottom of the cavity 20, and the first receptacle 16a and the second receptacle 16b define sides of the cavity 20. The upper cap 24 and the lower cap 26 enclose the first receptacle 16a and the second receptacle 16b, and connect the first receptacle 16a, the second receptacle 16b and the cavity 20 together.

In some embodiments, the first retaining portion 32 and the second retaining portion 34 are sized and shaped to snugly fit onto a corresponding receptacle. For example, the first retaining portion 32 may slide over a bottom of the first receptacle 16a so the inner surface of the first retaining portion 32 contacts an outer surface of the first receptacle 16a. Similarly, the second retaining portion 34 may slide over a bottom of the second receptacle 16b so the inner surface of the second retaining portion 34 contacts an outer surface of the second receptacle 16b. In some embodiments, the first retaining portion 32 and the second retaining portion 34 may have an open cup shape so that the receptacle fits into the retaining portion and the cup-shaped walls extend onto and around the receptacle. Put another way, the first retaining portion 32 may have an open cup shape configured to slidably couple to the first receptacle 16a, and the second retaining portion 34 may have an open cup shape configured to slidably couple to the second receptacle 16b. In some embodiments, there is a rubber gasket in the first retaining portion 32 and the second retaining portion 34 to facilitate a secure and snug fit to the first receptacle 16a and the second receptacle 16b respectively.

The base 36 has an inner surface configured to abut to an external structure when securing the battery holder. The external structure is a component of the EPTV such as the frame 28. In this configuration, the battery holder 14 along the central battery pack 22, is securely mounted to the EPTV, ensuring stable attachment to the frame 28. In some embodiments, the base 36 may include channels or cutouts (not shown) to allow for cable or wire routing. In this way, the base 36 may retain the cable and/or wires against the frame 28 preventing the cable and/or wires from being severed or damaged during use. In some embodiments, the lower cap 26 may be comprised of a cast, molded or formed material. In some embodiments, the lower cap 26 may be comprised of a rigid polymer such as Acrylonitrile Butadiene Styrene (ABS), or a composite material. In some embodiments, a portion of the lower cap 26 such as the base 36 may be flexible for case of installation.

A tether 38 is coupled to a receptacle (e.g., 16a or 16b) and the lower cap 26. The tether 38 may be a metal cable securely fastened by a mechanical fastener to the components. The tether 38 is a precautionary feature to prevent the lower cap 26 from falling away if dislodged during use or transport. This contributes to the safety and prevents potential hazards associated with the movement or detachment of the lower cap 26.

The first retaining portion 32, the second retaining portion 34 and the base 36 of the lower cap 26 may include internal ribs 40. The ribs 40 are projecting features that are distributed throughout the lower cap 26 and provide strength, rigidity, and functionality. The ribs 40 enhance the overall structural integrity of the lower cap 26 by reinforcing and strengthening areas, preventing deformation or failure under load or stress of the battery holder 14. By implementing ribs 40 in the lower cap 26, the load is distributed while resisting bending or flexing. The ribs 40 add strength to the design of the battery holder 14 while minimizing material usage. This allows for weight reduction in the overall battery holder 14 without compromising its mechanical performance.

To couple lower cap 26 to the receptacles 16a and 16b to secure the battery holder 14 to the frame 28 of the EPTV 30, in some embodiments, the first receptacle 16a and the second receptacle 16b each include a protrusion 42. These protrusions 42 of the second receptacle 16b couple to a corresponding aperture 44 of the first retaining portion 32. For example, the first retaining portion 32 of the lower cap 26 is coupled to the first receptacle 16a and the protrusion 42 of the first receptacle 16a is aligned with the aperture 44 of the retaining portion 32. The protrusion 42 may be maneuvered into the aperture 44. The protrusion 42 of the second receptacle 16b operates similarly to the aperture 44 of the second retaining portion 34.

In embodiments where the battery holder 14 includes only a single receptacle, the lower cap 26 is configured with a single corresponding retaining portion. Specifically, the lower cap 26 includes a base 36 and a single retaining portion 32 that couples to the receptacle 16a. In this configuration, the upper cap 24 defines the top of the cavity 20, while the base 36 of the lower cap 26 defines the bottom. The single receptacle 16a is adjacent to the cavity 20 and the upper cap 24 is coupled to a top surface of the receptacle 16a and covers the cavity. The upper cap 24 and the lower cap 26 enclose the receptacle 16a. Additionally, in some embodiments, the upper cap 24 includes a downward-extending panel (not shown) on its underside, featuring a protrusion 42 designed to align with a corresponding aperture 44. In this configuration, since there is only a single retaining portion 32, the corresponding aperture 44 may be positioned on the base 36 to facilitate secure attachment and stability.

In some embodiments, the base 36 of the lower cap 26 may include a keyhole 43 or a latch-knob hole. When the battery holder 14 is installed on the EPTV 30, the inner surface of the base 36 abuts to a component such as the frame 28. The keyhole 43 is an access point corresponding to a cam lock (or latch) integrated into the frame 28. This allows for the secure locking or unlocking of the battery holder 14 to the frame 28.

The upper cap 24 and the lower cap 26, along with the first retaining portion 32, the second retaining portion 34, and the base 36, collectively secure the one or more receptacles and the cavity 20, forming a closed loop system of the battery holder 14. When the battery holder 14 is installed on the EPTV 30, it helps prevent the one or more receptacles from catching on items such as clothing, landscape objects, structures, or the like, and thereby being twisted, torn off, or damaged. The features of the lower cap 26 ensure the battery holder 14 maintains a secure position if the EPTV falls over or is turned upside down such as during use or transport. The upper cap 24 and the lower cap 26 enhance the rigidity of the battery holder 14, eliminating the need to reinforce the one or more receptacles with metal framed components, reinforcing components, thicker components or the like.

FIG. 5A is a side view of a portion of an EPTV with the battery holder removed, and FIG. 5B is a top view of a portion of the frame of an EPTV with the battery holder removed, both in accordance with some embodiments. In these figures, an eBike is depicted as the representative EPTV; however, any EPTV, including those illustrated in FIGS. 1E-1K, may be used interchangeably. The frame 28 of the EPTV 30 includes a recess or opening 46 to accommodate the central battery pack 22 of the battery holder 14. While the frame 28 is used as the representative structural component, other structural elements of the EPTV, such as a downtube, rack, or panel, may also incorporate a opening 46 to accommodate the battery holder 14.

As shown in FIGS. 3A and 3B, this enables a portion (e.g., the central battery pack 22) to be integrated and hidden within the frame 28 and a portion of the battery holder 14 to be externally coupled to the frame 28. Put another way, a portion of the energy for the EPTV 30 is provided by batteries internally mounted within the frame 28 (or other component of the EPTV 30), and a portion of the energy for the EPTV 30 is provided by batteries externally mounted to the frame 28 (or other component of the EPTV 30). The EPTV 30 derives power from batteries that are both internally housed within the frame 28 (or another structural component of the EPTV 30) and externally attached to it, optimizing energy storage while maintaining a streamlined appearance. For example, with the outer battery packs 18 and the central battery pack 22 present in the battery holder 14, and the lower cap 26 uninstalled from the battery holder 14, the central battery pack 22 is inserted into the frame 28 of the EPTV 30. As a result, the first receptacle 16a contacts an outer surface of the frame 28, and the second receptacle 16b also contacts the outer surface of the frame 28. Once the battery holder 14 is firmly in place in the opening 46 of the frame 28, the lower cap 26 is installed as described herein. When mounted on the EPTV 30, the battery holder 14 provides a sleek, slender, low profile to the frame 28.

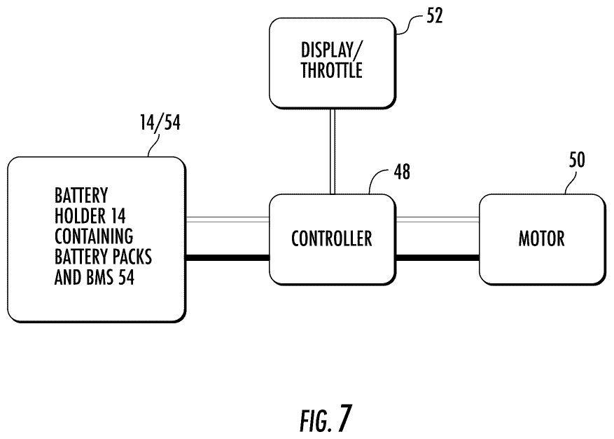

Electrical contacts 45 are located within opening 46 of the frame 28. The electrical contacts 45 establish a connection with the electrical contacts 31 of the central battery pack 22 when the battery holder 14 is installed on the EPTV 30, linking the central battery pack 22 to the motor 50 (see FIG. 7). The battery packs (central battery pack 22 and outer battery packs 18) may be charged through an electrical port 47 of the frame 28. Alternatively, the battery holder 14 may be removed from the EPTV 30 and the battery packs are charged through the electrical contacts 31 on the central battery pack 22.

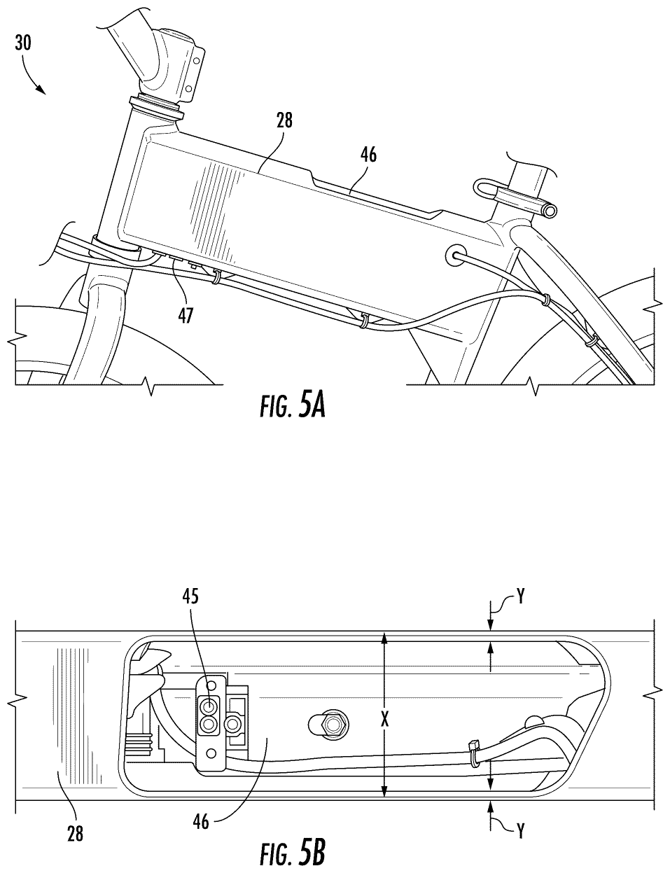

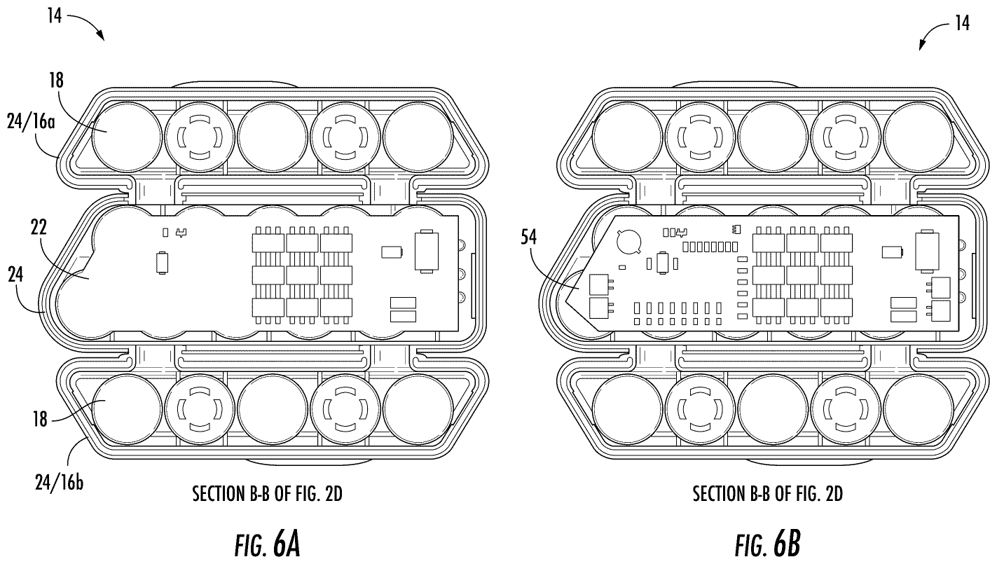

FIG. 6A shows a section view B-B of FIG. 2D excluding a battery management system (BMS), and FIG. 6B shows a section view B-B of FIG. 2D with a BMS, both in accordance with some embodiments.

FIG. 7 is an electrical schematic of the EPTV in accordance with some embodiments. A controller 48 includes a processor coupled to non-transient machine-readable media that is configured to manage and control various electrical functions of the EPTV 30. For example, the controller 48 manages and controls various electrical functions of the EPTV 30. It is electrically connected to a battery management system (BMS) 54, a motor 50 and a display/throttle 52 of the EPTV 30, and controls power distribution, motor functions, and user interaction. The one or more receptacles, such as the first receptacle 16a and/or the second receptacle 16b, may include through ports (not shown) that extend through its thickness, allowing for an unobstructed passage from one side to the other to accommodate the routing of wires from the BMS 54 to the controller 48.

The BMS 54 includes a processor coupled to non-transient machine-readable media that is configured to manage and control the battery packs of the EPTV 30. The BMS 54 is configured to monitor and manage each battery cell of the outer battery packs 18 and the central battery pack 22, including voltage levels, temperature, and overall health. It may implement safety features to prevent overcharging, over-discharging, and overheating. The BMS 54 regulates the power flow from the outer battery packs 18 and the central battery pack 22 and is connected to the controller 48. The controller 48 interfaces with the user controls such as the display/throttle 52 and translates a user input into commands for the motor 50 and adjusts the power output to the motor 50 accordingly. This control mechanism determines the speed and acceleration of the EPTV 30.

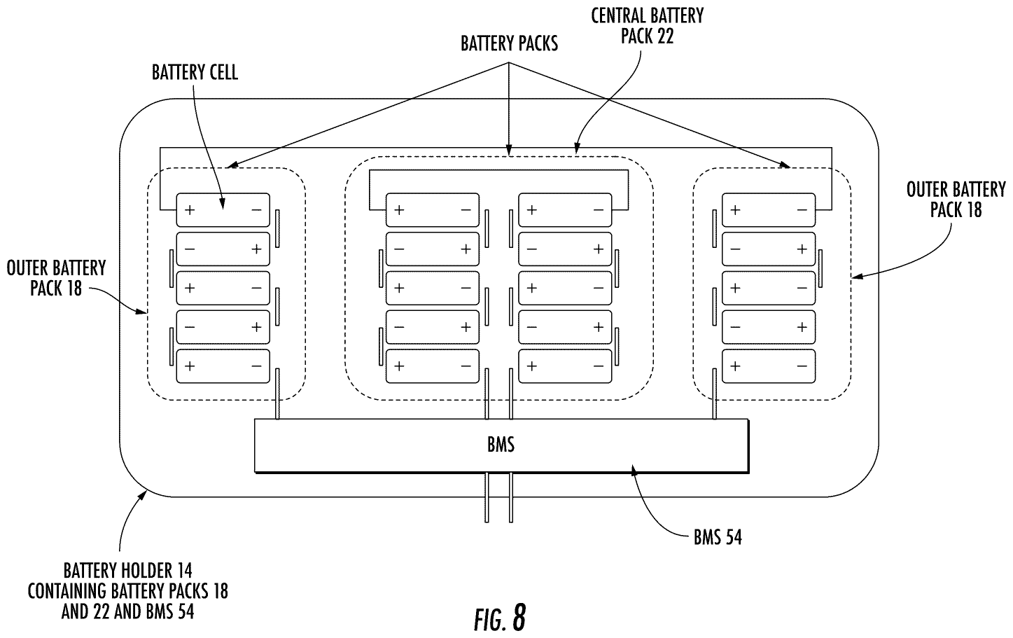

FIG. 8 is an electrical schematic of the battery management system (BMS) and battery cells, in accordance with some embodiments. Electrical wiring is shown in FIG. 8 by lines coupling the batteries, the battery packs, and the BMS 54 to one another. The BMS 54 is configured to actively monitor and control various parameters to optimize performance while preventing potential issues that could lead to damage or reduced battery life. The electrical wiring is configured to electrically connect the first receptacle 16a to the BMS 54, electrically connect the second receptacle 16b to the BMS 54, and electrically connect the cavity 20 to the BMS 54. The cavity 20 is configured to mount within the component of the electric personal transport vehicle.

In some embodiments, the outer battery packs 18 in the first receptacle 16a and the second receptacle 16b, and the central battery pack 22 in the cavity 20, comprise rechargeable batteries such as lithium-ion cells. In other embodiments, the outer battery packs 18 and the central battery pack 22 may be lithium polymer batteries, lithium-sodium batteries, Nickel-Metal Hydride (NiMH) batteries, or a combination thereof.

Referring to FIG. 8, FIG. 6A and FIG. 6B, the first receptacle 16a and the second receptacle 16b are each configured to accommodate an outer battery pack 18. In some embodiments, each outer battery pack 18 includes battery cells such as five battery cells connected end-to-end in series to increase the voltage output. The outer battery pack 18 with five cells in the first receptacle 16a, and the outer battery pack 18 with five cells in the second receptacle 16b, are connected in series, which results in a nominal voltage of 36V (i.e., each cell has a nominal voltage of 3.6V). These outer battery packs 18 create a first set of ten cells. The central battery pack 22 includes battery cells such as ten battery cells connected end-to-end in series, which results in a nominal voltage of 36V (i.e., each cell has a nominal voltage of 3.6V). This central battery pack 22 creates a second set of ten cells.

To increase the current output, the first set of ten cells or the outer battery packs 18, and the second set of ten cells or the central battery pack 22, are connected in parallel, which results in a nominal capacity of 9.6 Amp hour (Ah) (i.e., each cell has a nominal capacity of 0.48 Ah). This configuration offers a balance between voltage and capacity. The number of battery cells in each outer battery pack 18 or the central battery pack 22 can be adjusted to modify the overall voltage and capacity of the system. For example, additional cells can be included to increase voltage output, while fewer cells can be used for lower power requirements, allowing flexibility in energy storage and performance based on specific EPTV need. Based on the factors of battery capacity, voltage, efficiency of the system, and the energy consumption of the EPTV 30, the battery holder 14 may provide ranges of 22 to 25 miles, 21 to 24 miles, 23.5 to 24.5 miles, or 24 miles before the battery packs need recharging.

To describe the electrical connections of the battery packs in another way, the electrical wiring is configured to electrically couple battery cells of the first battery pack (e.g., the outer battery pack 18 in the first receptacle 16a) in series, and electrically couple battery cells of the second battery pack (e.g., the outer battery pack 18 in the second receptacle 16b) in series. The electrical wiring is configured to electrically couple battery cells of the second battery pack (e.g., the outer battery pack 18 in the second receptacle 16b) to the battery cells of the first battery pack (e.g., the outer battery pack 18 in the first receptacle 16a) in series. The electrical wiring is configured to electrically couple the battery cells of the first battery pack (e.g., the outer battery pack 18 in the first receptacle 16a) and the second battery pack (e.g., the outer battery pack 18 in the second receptacle 16b) to the third battery pack (e.g., the central battery pack 22) in parallel.

The BMS 54 monitors the individual cells within the outer battery packs 18 and the central battery pack 22 to ensure that they have similar voltage levels. The BMS 54 implements balancing by redistributing energy to equalize the cell voltages if some cells are charged or discharged more than others which aids to maximize the overall capacity and lifespan of the battery.

In some embodiments, the BMS 54 is coupled to an inner surface of the upper cap 24. Electrical wiring is configured to electrically couple a first battery pack, or the outer battery pack 18, disposed in the first receptacle 16a to the BMS 54. The electrical wiring is configured to electrically couple a second battery pack, or the outer battery pack 18, disposed in the second receptacle 16b to the BMS 54. The electrical wiring is configured to electrically couple a third battery pack, or the central battery pack 22, disposed in the cavity 20 (as shown in FIG. 2B) to the BMS 54. The third battery, or the central battery pack 22, is configured to mount within an opening 46 formed in the frame 28 (or another component of the EPTV 30).

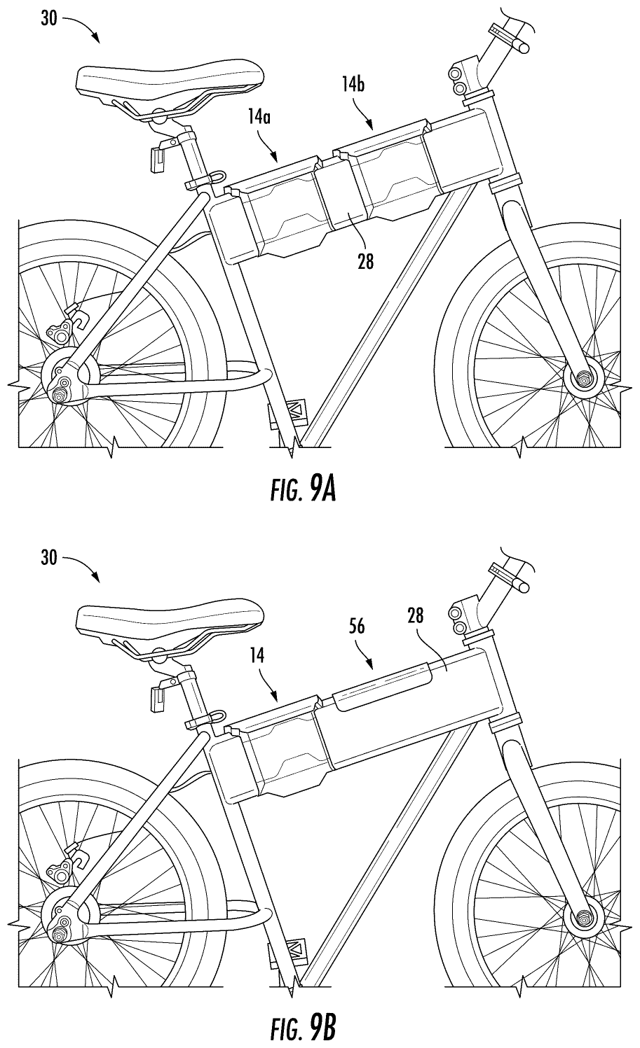

FIG. 9A shows a side view of an EPTV, in accordance with some embodiments. In this example, an eBike is depicted as the representative EPTV; however, any EPTV, including those illustrated in FIGS. 1E-1K, may be used interchangeably. The EPTV 30 may include a first battery holder 14a and a second battery holder 14b housing the appropriate battery packs. The first battery holder 14a and the second battery holder 14b are installed in the frame 28 of the EPTV 30 in an aesthetically pleasing configuration. As such, the central battery packs 22 of the first battery holder 14a and the second battery holder 14b are integrated and hidden within the frame 28 while the first receptacle 16a and the second receptacle 16b of the first battery holder 14a and the second battery holder 14b contact the outer surface of the frame 28. In some embodiments, the first receptacle 16a of the first battery holder 14a and the first receptacle 16a of the second battery holder 14b may be combined into a single, larger first receptacle 16a, enhancing structural integration and stability. Similarly, the second receptacle 16b of the first battery holder 14a and the second receptacle 16b of the second battery holder 14b may be merged into a single, larger second receptacle 16b, streamlining the design while maintaining secure attachment and efficient battery placement.

This dual battery configuration significantly extends the mileage range of the EPTV 30 before having to recharge the battery packs. In some embodiments, the first battery holder 14a and second battery holder 14b may each provide a 24-mile range or collectively, a 48-mile range before the battery packs need recharging.

FIG. 9B is a side view of an EPTV, in accordance with some embodiments. In this example, an eBike is depicted as the representative EPTV; however, any EPTV, including those illustrated in FIGS. 1E-1K, may be used interchangeably. The EPTV 30 includes the battery holder 14 and another type of battery holder 56. In this configuration, the battery holder 14 is as described herein. In some embodiments, the battery holder 56 may include a single battery pack coupled to a top cover. The single battery pack may be installed into an opening of the frame 28 thereby integrating that portion in the frame 28. The top cover of the battery holder 56 then completely covers the opening in the frame 28 contacting the frame 28.

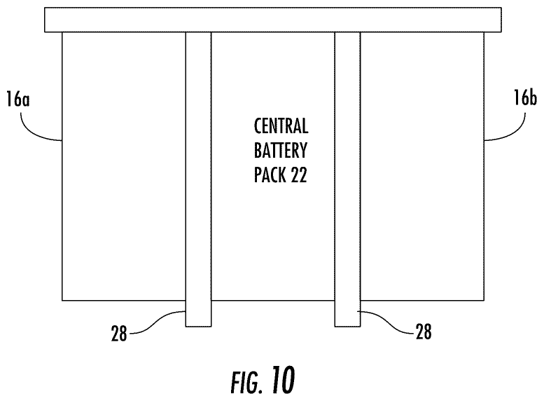

FIG. 10 is a schematic for a configuration for the battery holder for an EPTV, in accordance with some embodiments. The configuration of FIG. 10 depicts the arrangement as described herein with the first receptacle 16a for the outer battery pack 18, the second receptacle 16b for the outer battery pack 18, and the central battery pack 22 located between the first receptacle 16a and the second receptacle 16b. The central battery pack 22 is inserted into an opening on the frame of the EPTV 30.

Reference has been made in detail to embodiments of the disclosed invention, one or more examples of which have been illustrated in the accompanying figures. Each example has been provided by way of explanation of the present technology, not as a limitation of the present technology. In fact, while the specification has been described in detail with respect to specific embodiments of the invention, it will be appreciated that those skilled in the art, upon attaining an understanding of the foregoing, may readily conceive of alterations to, variations of, and equivalents to these embodiments. For instance, features illustrated or described as part of one embodiment may be used with another embodiment to yield a still further embodiment. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

What is claimed is:

1. A battery holder for an electric personal transport vehicle comprising:
a first receptacle and a second receptable, each receptacle configured to accommodate an outer battery pack;
a cavity between the first receptacle and the second receptacle, the cavity configured to accommodate a central battery pack;
an upper cap coupled to a top surface of the first receptacle and the second receptable, and covering the cavity; and
a lower cap comprising:
a first retaining portion coupled to the first receptacle;
a second retaining portion coupled to the second receptacle; and
a base between and coupled to each of the first retaining portion and the second retaining portion, the base covering the cavity, wherein the base has an inner surface configured to abut to an external structure when securing the battery holder, wherein the external structure is a component of the electric personal transport vehicle.

2. The battery holder of claim 1, wherein the upper cap defines a top of the cavity, the base of the lower cap defines a bottom of the cavity, and the first receptacle and the second receptacle define sides of the cavity.

3. The battery holder of claim 1, wherein the upper cap and the lower cap enclose the first receptacle and the second receptacle, and connect the first receptacle, the second receptacle and the cavity together.

4. The battery holder of claim 1, wherein the first receptacle, the second receptacle, the lower cap, and the upper cap are each made from a cast, molded or formed material.

5. The battery holder of claim 1, wherein the first retaining portion and the second retaining portion comprise an open cup shape configured to slidably couple to the first receptacle and the second receptacle respectively.

6. The battery holder of claim 1, wherein the first receptacle comprises a protrusion that couples to a corresponding aperture of the first retaining portion.

7. The battery holder of claim 1, wherein:
the second receptacle comprises a protrusion that couples to a corresponding aperture of the second retaining portion.

8. The battery holder of claim 1, wherein the upper cap further comprises:
a battery management system coupled to an inner surface of the upper cap, wherein the battery management system is configured to monitor and manage the outer battery packs and the central battery pack, including voltage levels, temperature, and overall health.

9. The battery holder of claim 8, further comprising electrical wiring configured to:
electrically connect the first receptacle to the battery management system;
electrically connect the second receptacle to the battery management system; and
electrically connect the cavity to the battery management system, wherein the cavity is configured to mount within the component of the electric personal transport vehicle.

10. The battery holder of claim 1, wherein the first receptacle contacts an outer surface of the component of the electric personal transport vehicle when the battery holder is installed to on the electric personal transport vehicle.

11. The battery holder of claim 1, wherein the second receptacle contacts an outer surface of the component of the electric personal transport vehicle when the battery holder is installed to on the electric personal transport vehicle.

12. The battery holder of claim 1, further comprising:
a tether coupled to the first receptacle or the second receptacle, and the lower cap.
